(19) United States
(12) Patent Application Publication
(10) Pub. No.: US 2014/0223759 A1
(43) Pub. Date: Aug. 14, 2014

(54) CARWASH DRIER APPARATUS WITH A STAND

(71) Applicant: Harry Konstantino Gougoulas, Riverview, MI (US)

(72) Inventor: Harry Konstantino Gougoulas, Riverview, MI (US)

(21) Appl. No.: 14/163,655

(22) Filed: Jan. 24, 2014

Related U.S. Application Data
(60) Provisional application No. 61/763,201, filed on Feb. 11, 2013.

(51) Int. Cl. F26B 5/00

(52) U.S. Cl. CPC F26B 5/00
USPC 34/90

(57) ABSTRACT

A drier station for a carwash having an air duct that moves up and down a stand. As a vehicle passes through the drier station, proximity sensors detect the position of the vehicle and the air duct moves up and down the stand to follow the contours of the vehicle. The air duct is rotatable along a plane generally orthogonal to an axis of the stand to allow the air duct to rotate away from the vehicle if the air duct contacts the vehicle.

### CROSS-REFERENCE TO RELATED APPLICATIONS

This application claims priority of U.S. Provisional Application 61/763,201 filed Feb. 11, 2013, the contents of which are incorporated herein by reference.

### FIELD OF THE INVENTION

The invention is related to a drier station used in a carwash. In particular, the disclosure is related to an air duct mounted upon a stand.

### BACKGROUND OF THE INVENTION

An automated carwash includes automated equipment that sprays water, soap and other products upon a car within the carwash. A carwash can include a stationary vehicle, with robotic spray equipment traveling around the vehicle. A carwash can include a chain drive or other mechanism to pull a vehicle through a set of stationary spray stations.

A carwash can include a drying station where high velocity air is blown upon the vehicle to dry the vehicle. An air duct is supplied with a flow of high velocity air, and an outlet or a plurality of outlets upon the air duct channel direct high velocity output air upon the vehicle being dried. A drying station can be stationary, with a vehicle either being pulled through the drying station or with the driver of the vehicle driving the vehicle through the drying station.

### SUMMARY OF THE INVENTION

A drier station for a carwash is provided. The drier station has an air duct fixedly mounted to a sleeve. The sleeve moves up and down a stand. As a vehicle passes through the drier station, proximity sensors detect the position of the vehicle. A control module in communication with a drive receives information from the proximity sensors. The control module processes the signal from the proximity sensors and controls the movement of the sleeve up and down the stand to follow the contours of the vehicle. The air duct is rotatable along a plane generally orthogonal to an axis of the -stand to allow the air duct to rotate away from the vehicle if the air duct contacts the vehicle. Additionally, the stand may be configured to allow the air-duct to slide upwards away from the vehicle.

In an embodiment of the present invention, the stand and the sleeve have a rectangular cross section. A hinge assembly, having a hinge body and a hinge arm, is mounted to the sleeve. The hinge body receives the hinge arm and the hinge arm is fixedly mounted to the air duct. The air duct and the hinge arm are rotatable about the hinge body along a plane generally orthogonal to the axis of the stand.

The air duct is rotatable between a drying position and a displaced position. In the drying position the air duct extends outward from the stand to dry the vehicle. In the displaced position the air duct is rotated away from the drying position to allow the vehicle to pass through the drier station. In the event that the vehicle contacts the air duct, the air duct displaces from the drying position so as to clear a path for the advancement of the vehicle.

The hinge body may include a resting channel dimensioned to hold the hinge arm and the air duct in a fixed relationship with the hinge body. The resting channel is on a top surface of the hinge body. A portion of the top surface is coplanar with the hinge arm. The resting channel has a first and second side which are angled outward with respect to each other to form a generally “V” shape. The bottom of the resting channel is generally planar and has a width approximately the diameter of a portion of the hinge arm. In the drying position, the hinge arm resides in the resting channel and holds the air duct in the drying position. The hinge arm may be held in the resting channel by the weight of the air duct or forcibly by a spring, pneumatic cylinder, or the like.

The hinge body may include a sloped surface that is configured to urge the hinge arm to the displaced position when the air duct is moved from the drying position. The sloped surface declines from a distal end of the hinge body towards the stand so that when the hinge arm is moved from the drying position, the sloped surface urges the hinge arm and the air duct to continue to rotate towards the displaced position.

The hinge body may include a stop configured to prevent the hinge arm from rotating beyond the drying position. The stop may be disposed on a surface of the hinge body coplanar with the hinge arm. The drying station also has a return device configured to return the air duct from the displaced position to the drying position. The return device may further hold the hinge arm in contact with the stop. The return device may be a spring, pneumatic cylinder, hydraulic cylinder, or motor; although one skilled in the art will appreciate that other return devices may be used.

In another embodiment, the hinge arm is held in the drying position by a pair of springs mounted on opposite sides of the air duct. The pair of springs are biased against one another such that when the springs are in equilibrium, the air duct is in the drying position. When the air duct is displaced from the drying position, the pair of springs return the air duct to the drying position.

The sleeve may include a plurality of roller wheels in contact with the stand. The roller wheels are aligned with the axis of the stand so as to aid the movement of the sleeve up and down the axis of the stand. One skilled in the art will appreciate that bearings or other known friction decreasing devices can be used to aid the movement of the sleeve up and down the axis of the stand.

In another embodiment of the present invention, the stand and the sleeve have a circular cross section. The air duct is fixedly mounted to the sleeve which is rotatable about the stand along a plane generally orthogonal to the axis of the stand. In the event that the vehicle contacts the air duct, the air duct rotates from the drying to a displaced position.

The circular sleeve may have a plurality of bearings in contact with the stand. The bearings allow the sleeve to move up and down while also rotating about the axis of the stand. One skilled in the art will appreciate that other known friction decreasing devices can be used to aid the movement of the sleeve.

### BRIEF DESCRIPTION OF THE DRAWINGS

One or more embodiments will now be described, by way of example, with reference to the accompanying drawings, in which:

FIG. 1 is a isometric view of a drier station;

FIG. 2 is top view of an exemplary drier station having roller wheels;

FIG. 3 is an alternative embodiment of the drier station;

FIG. 4 is an alternative embodiment of the drier station;

FIG. 5 is an alternative embodiment of the drier station;

FIG. 6 is an alternative embodiment of the drier station;

FIGS. 7A-7C are isometric views showing the operation of a hinge body having a resting channel and a sloped surface;

FIG. 8 is an alternative embodiment of the drier station;

FIG. 9 is a cross sectional view of the rectangular sleeve having roller wheels;

FIG. 10 is a cross sectional view of the circular sleeve having bearings;

FIG. 11 is an alternative embodiment of the hinge body;

FIG. 12 is an alternative embodiment of the drier station showing the air duct configured to dry the side surface of the vehicle.

### DETAILED DESCRIPTION OF THE PREFERRED EMBODIMENTS

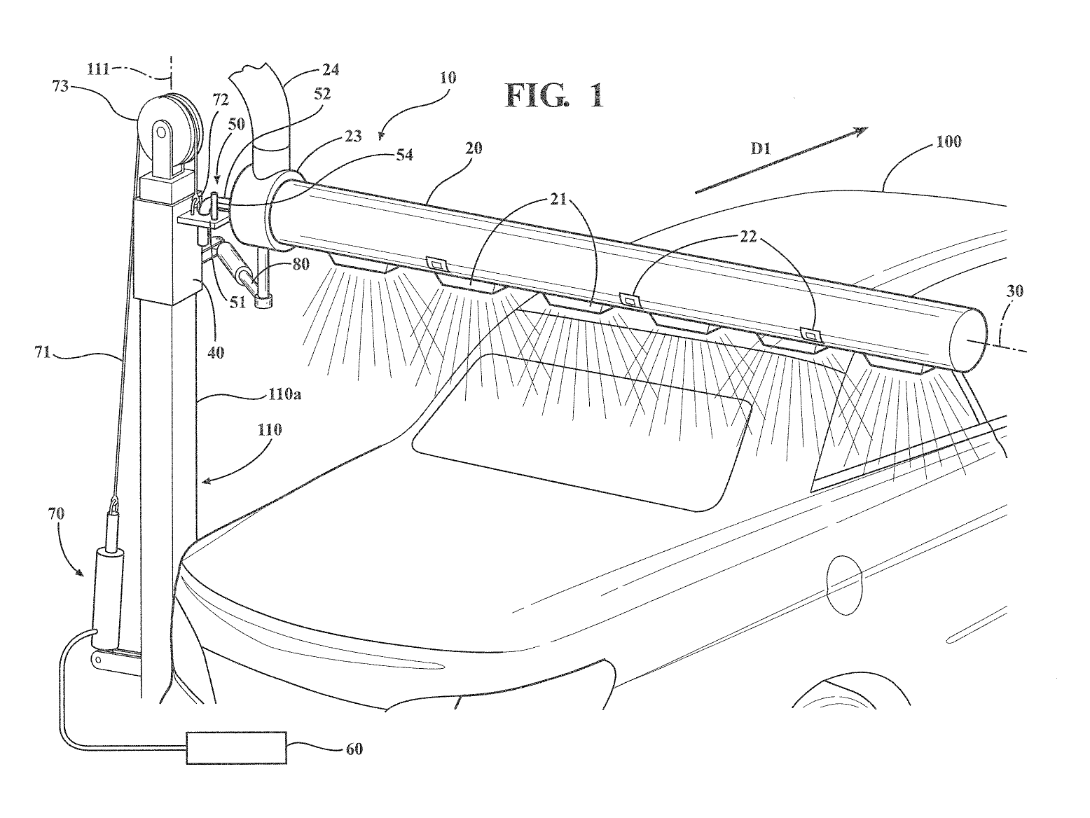

Referring now to the drawings, a drier station 10 is provided. FIG. 1 illustrates an exemplary drier station 10 with an air duct 20 suspended in a drying position 30 to dry a vehicle 100 in a carwash. The drier station 10 includes an air duct 20, a sleeve 40, a hinge assembly 50, a control module 60, a drive 70, and a stand 110 having an elongated portion 110a. The stand 110 is generally shown as an elongated pole which is mounted to the ground and is generally upright.

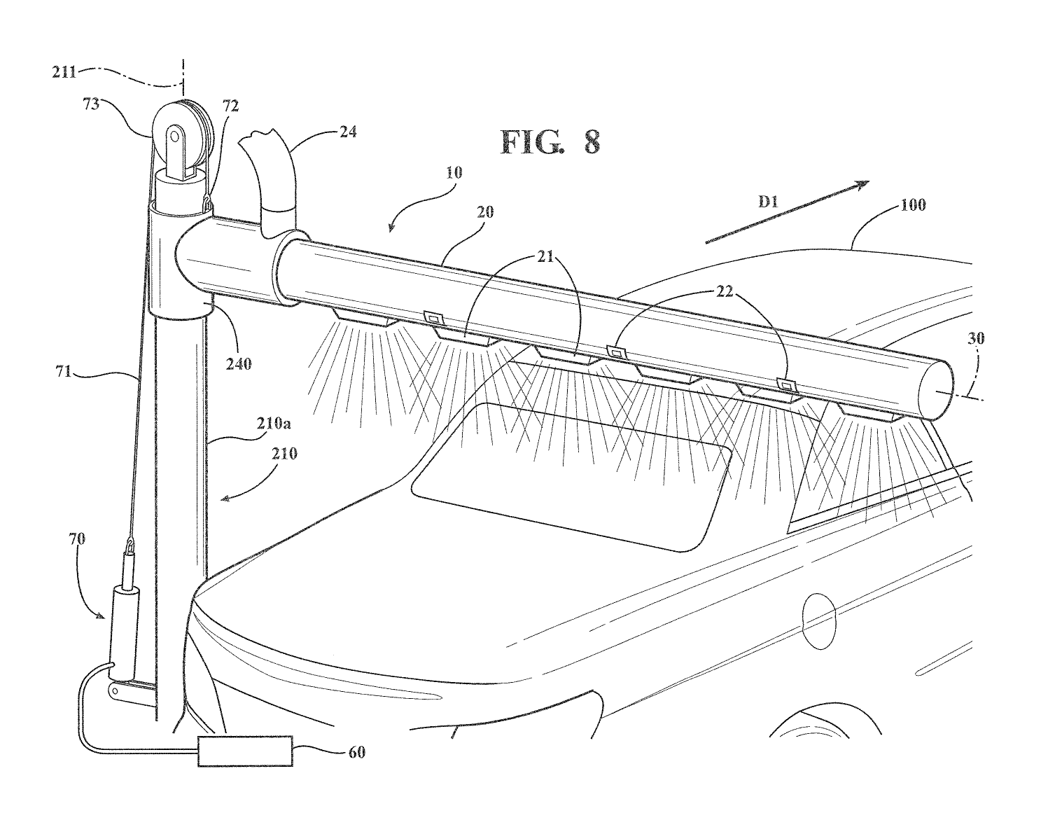

The sleeve 40 is dimensioned to fit around the elongated portion 110a and moves up and down along a predetermined length of the elongated portion 110a of the stand 110. Accordingly, the sleeve 40 may move upwardly with respect to the vehicle 100 in the event the vehicle 100 comes into contact with the air duct 20. The stand 110 may either be located on the driver side of the vehicle 100 or the passenger side of the vehicle 100. The stand 110 and the sleeve 40 may have a rectangular cross section as shown in FIGS. 1-6 and 9 or a circular cross section as shown in FIGS. 8 and 10.

The air duct 20 includes a plurality of outlets 21 configured to direct high velocity output air upon the vehicle 100 located beneath the air duct 20. A plurality of proximity sensors 22 are used to sense the location and distance between the vehicle 100 and the air duct 20. Though the Figures show the proximity sensors 22 placed directly upon the air duct 20, it should be appreciated that the proximity sensors 22 may be located remotely from the air duct 20. The control module 60 receives a signal from the proximity sensors 22 and controls the drive 70 to move the sleeve 40 up and down the elongated portion 110a of the stand 110.

The air duct 20 can be round, square or include any cross-sectional shape. The air duct 20 can have a uniform cross section along the air duct 20, or the cross-sectional shape can vary along the length of the air duct. The air duct 20 can be constructed of a rigid material, for example, a rigid plastic case or an inflatable flexible material properly supported. The air duct 20 is connected to an air duct bracket 23. The air duct bracket 23 is connected to a supply tube 24 providing high velocity air. The high velocity air is channeled through the air duct bracket 23 into the air duct 20.

The air duct bracket 23 is attached to a hinge body 51 through a hinge arm 52, such that the air duct 20 can be moved from the drying position 30 to the displaced position 32. In one embodiment, the air duct bracket 23 could be eliminated, and a rigid air duct 20 could be attached directly to the sleeve 40. The air duct 20 and any attached equipment or structures can be described as a swinging arm.

In the drying position 30, the air duct 20 is suspended over the vehicle 100 so as to direct air onto the vehicle 100. In the event that the vehicle 100 moves into contact with the air duct 20, the hinge arm 52 is configured to give way to the vehicle 100 and position the air duct 20 in the displaced position 32. The displaced position 32 is defined as when the air duct 20 has been displaced or pushed out of the drying position 30.

The sleeve 40 is configured to move slidingly up and down the elongated portion 110a of the stand 110. The sleeve 40 can include bearings, roller wheels, lubrication, or some other means to reduce friction between the sleeve 40 and the elongated portion 110a and facilitate the movement of the sleeve 40 to up and down along the axis 111 of the elongated portion 110a of the stand 110. A support cable 71 is illustrated attached to the sleeve 40 at a connection point 72. The control module 60 controls the drive 70 to move the sleeve 40 up or down the elongated portion 110a. The support cable 71 is routed through a pulley 73 to permit a downward force from the drive 70 to result in an upward force upon the sleeve 40. The drive 70 can include a pneumatic or hydraulic cylinder known in the art. The drive 70 can further include an electric motor pulling upon the support cable 71 or any control mechanism known in the art capable of moving the support cable 71. In an alternative embodiment of the drive 70, the drive 70 may be mounted directly to the sleeve 40 so as to drive the sleeve 40 along the elongated portion 110a of the stand 110. The control module 60 is configured as disclosed herein to monitor signals from the proximity sensors 22 and control the drive 70.

The hinge assembly 50 is mounted to the sleeve 40. The hinge assembly 50 has a hinge body 51 and a hinge arm 52. The hinge body 51 is adapted to receive the hinge arm 52, preferably in a central region of the hinge body 51. The hinge assembly 50 can include a stop 54 on a surface of the hinge body 51 coplanar with the hinge arm 52. The stop 54 is configured to prevent the hinge arm 52 from rotating beyond the drying position 30. The drier station can further include a return device 80 to return the air duct 20 to the drying position 30. The return device 80 also holds the hinge arm 52 in contact with the stop 54 to ensure that the air duct 20 is in the drying position 30. The return device may be, for example, a pneumatic cylinder, hydraulic cylinder, or a spring.

The vehicle 100 progresses through the drier station 10 along direction D1. The control module 60 receives signals from the proximity sensors 22 and controls the drive 70 to move the sleeve 40 up and down the elongated portion 110a to follow the shape of the vehicle 100. As the sleeve 40 and the air duct 20 follow the shape of the vehicle 100, high pressure air is directed by the outlets 21 onto the vehicle 100.

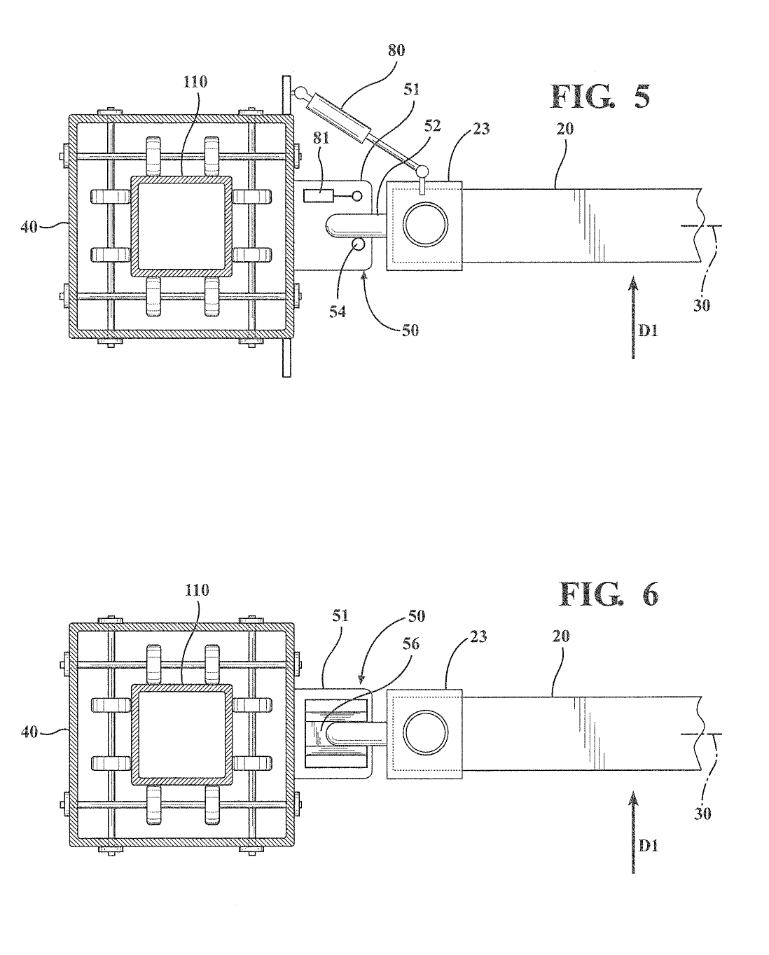

The hinge assembly 50 is mounted to the sleeve 40. The air duct 20 is fixedly mounted to the hinge arm 52 and the hinge body 51 receives the hinge arm 52. The air duct 20 and the hinge arm 52 are rotatable about the hinge body 51 between the drying position 30 and the displaced position 32. The air duct 20 is movable from the drying position 30 to the displaced position 32 such as when the vehicle 100 contacts the air duct 20 while moving in direction D1. The return device 80 is configured to return air duct 20 from the displaced position 32 to the drying position 30. The return device may be further configured to perform other functions such as absorbing the pulsation shock of the high velocity air discharge of the air duct 20 and also initiating the displacements of the air duct 20 when needed by triggering switch 81 FIG. 5.

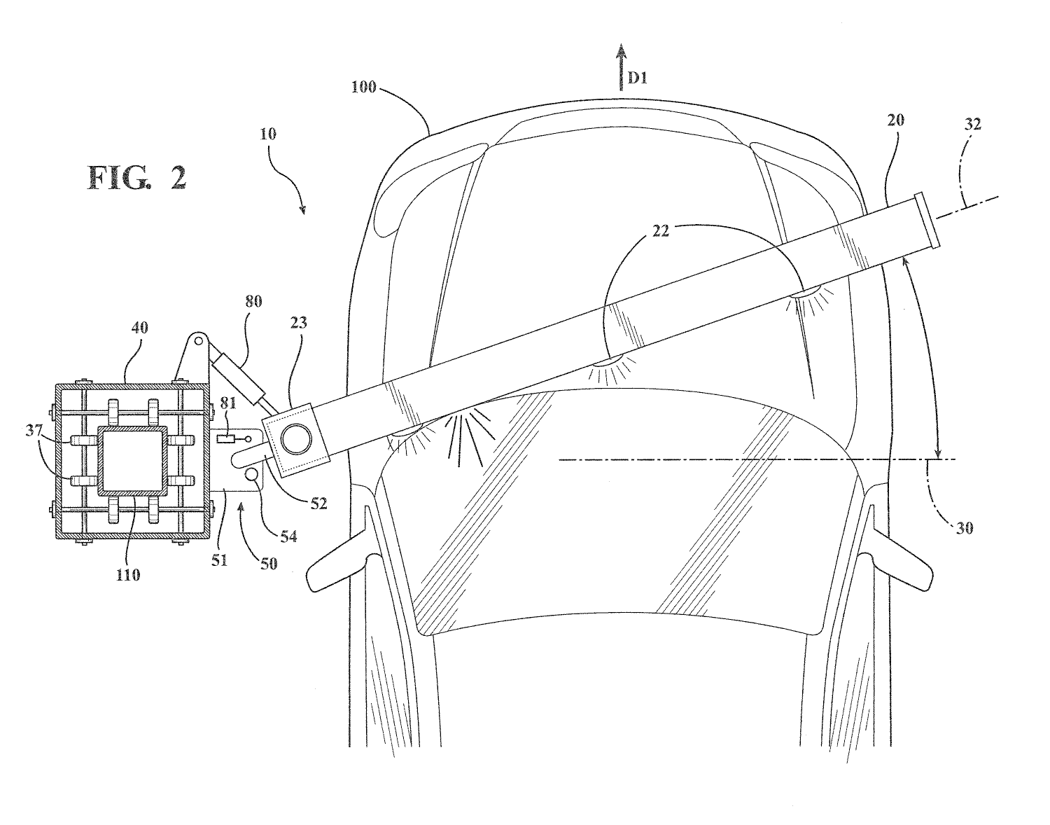

FIG. 2 illustrates a top view of an exemplary drier station having roller wheels 37. The air duct 20 is illustrated in the displaced position 33. The proximity sensors 22 are illustrated upon the air duct 20. The air duct bracket 23 is illustrated including an exemplary round opening configured to receive a supply tube 24. The air duct 20 is connected to the air duct bracket 23. The air duct bracket 23 is attached to the hinge body 51 through the hinge arm 52. The sleeve 40 is illustrated located to the elongated portion 110a with exemplary roller wheels 37 attached to the sleeve 40 and interacting with elongated portion 110a.

The roller wheels 37 are in contact with the elongated portion 110a of the stand 110 and are further aligned with the axis 111 of the stand 110. A number of roller wheels 37 configurations are known in the art, and any similar roller bearing configuration known in the art capable of acting as an interface between the sleeve 40 and the stand 110 can be used. For example, roller bearings may be substituted for the roller wheels 37 on the sleeve 40. The stand 110 is illustrated as having a square cross section, although a number of elongated portion 110a configurations with different cross sections can be utilized.

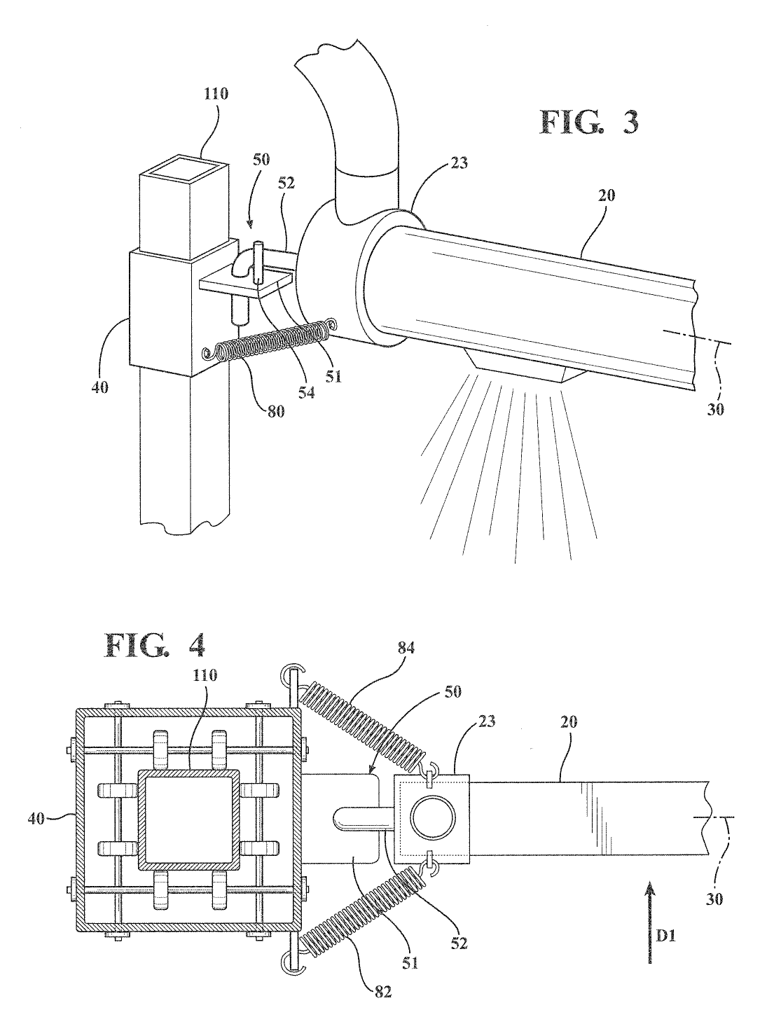

FIGS. 3-6 illustrate exemplary configurations of the hinge assembly 50 and the return device 80. In FIG. 3, the hinge body 51 receives the hinge arm 52 and includes stop 54 on a top surface of the hinge body 51 coplanar to the hinge arm 52. The stop 54 prevents the air duct 20 from rotating beyond the drying position 30. In this exemplary embodiment, the return device 80 is a spring configured to restore the air duct 20 to the drying position 30 when it is moved to the displaced position 32.

In the exemplary embodiment of FIG. 4, a pair of springs 82, 84 are provided to restore the air duct 20 to the drying position 30 when it is moved to the displaced position 32. The pair of springs 82, 84 are affixed to opposing sides of the air duct bracket 23 and biased against one another so that the air duct 20 is held in the drying position 30 when the pair of springs 82, 84 are in equilibrium. One of the pair of springs 82 is mounted to a first side of the air duct 20 and the other of the pair of springs 84 is mounted on the opposite side of the air duct 20. The hinge arm 52 and the air duct 20 rotate about the hinge body 51. In this exemplary embodiment, the pair of springs 82, 84 are configured to restore the air duct 20 to the drying position 30 when it is moved to the displaced position 32.

In FIG. 5, the hinge body 51 is depicted receiving the hinge arm 52 and further including a stop 54 on a surface of the hinge body 51 coplanar to the hinge arm 52. The stop 54 prevents the air duct 20 from rotating beyond the drying position 30. In this exemplary embodiment, the return device 80 is a cylinder 80 driven by a fluid such as a liquid or air, commonly referenced as a hydraulic or pneumatic cylinder, respectively. The cylinder is configured to facilitate the movement of the air duct 20 from the drying position 30 to the displaced position 32 and also to restore the air duct 20 to the drying position 30 when it is moved to the displaced position 32. The return device 80 also is further configured to perform additional functions such as absorbing the pulsation shock of the high velocity air discharge of the air duct and also initiating the displacements of the air duct 20 when needed by triggering switch 81 FIG. 5. The return device 80 is shown as an air cylinder. The cylinder 80 is also configured to move the air duct 20 forward and/or upwards when the air duct 20 is pushed forward by a vehicle 100 from the drying position.

The activating switch 81 may be in electrical communication with both the return device 81 and the drive 70. The switch 81 may be configured to both manually activate the return device 80 and/or the drive 70 so as to selectively pivot the air duct 20 or move the air duct 20 up along the elongated portion 110a of the stand 110. The activating switch 81 may be further configured to sound an alarm for the car wash attendant. Thus in one mode of operation, the user may actuate the activating switch 81 so as to engage the drive 70, wherein the air duct 20 is moved to the displaced position. In such a mode of operation, the displaced position is such that the air duct 20 is positioned above the roof of the vehicle 100 so as to provide a passage for the vehicle 100. In another mode of operation, the user may actuate the activating switch 81 so as to engage the return device 80, moving the air duct 20 to the displaced position. In such a mode, the displaced position is such that the air duct 20 is pivoted away from the advancing vehicle 100 so as to provide a passage for the vehicle 100. In yet another mode of operation the user may actuate the activating switch 81 so as to engage both the return device 80 and the drive 70 moving the air duct 20 to the displaced position. In such a mode, the displaced position 32 is such that the air duct 20 is rotated about the stand 110 along a plane generally orthogonal to the axis of the stand 110 and rotated 90 degrees from the drying position and the drive 70 urges the sleeve 40 upwardly so as to move the air duct 20 to the highest permissible part of the stand 110.

In FIG. 6, the hinge body 51 is shown having a resting channel 56. The resting channel 56 is dimensioned to receive the hinge arm 52. The resting channel 56 holds the hinge arm 52 in a fixed relationship with the hinge body 51, preferably in the drying position 30. The resting channel 56 is on a top surface of the hinge body 51. A portion of the top surface of the hinge body 51 is coplanar with the hinge arm 52.

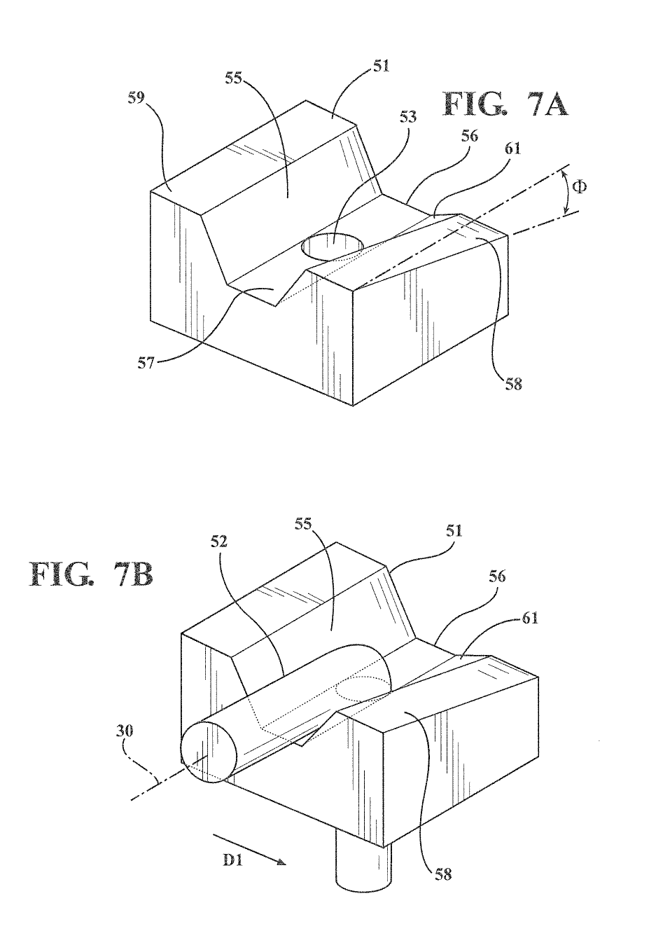

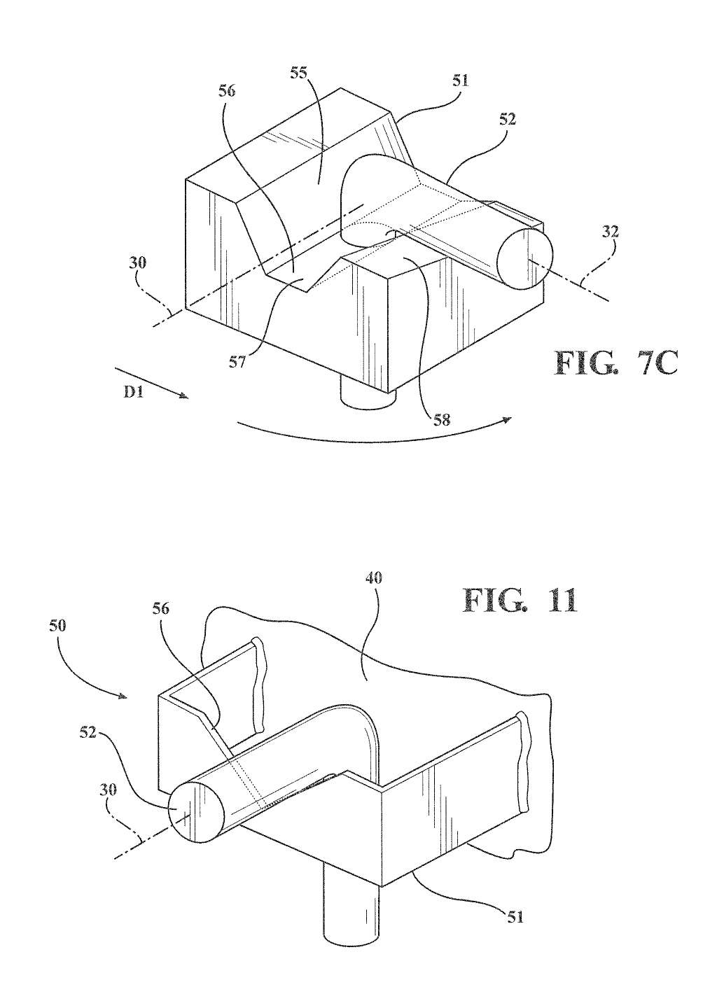

FIGS. 7A-7C illustrate the operation of the exemplary hinge body 51 configuration from FIG. 6. The resting channel 56 is used to orient hinge arm 52 in the drying position 30 and the air duct 20 can be displaced by application of a mechanical force to the hinge arm 52. FIG. 7A illustrates an exemplary hinge body 51 which can be welded or otherwise affixed to the sleeve 40. The resting channel has a first side 55 and a second side 61 which are angled outward with respect to each other to form a generally “V” shape. The bottom 57 of the resting channel 56 is generally planar and has a width approximately the diameter of a portion of the hinge arm 52. In the drying position 30, the hinge arm 52 resides in the resting channel 56 and holds the air duct 20 in the drying position 30. The hinge arm 52 may be held in the resting channel 56 by the weight of the air duct 20 or forcibly by a spring, pneumatic cylinder, or the like.

A stop side 59 of the hinge body 51 above the resting channel 56 is elevated to prevent the hinge arm 52 from moving beyond the drying position 30 in that direction. A sloped surface 58 of the hinge body 51 above the resting channel 56 is similarly elevated to prevent the hinge arm 52 from moving towards the displaced position 32. At rest and with no forces acting upon the hinge arm 52, the hinge arm 52 rests in the resting channel 56. The resting channel 56 can be oriented such that an air duct 20 is situated in the drying position 30 over a vehicle 110 moving in direction D1.

The hinge body 51 may include a sloped surface 58 that is configured to urge the hinge arm 52 to the displaced position 32 when the air duct 20 is moved from the drying position 30. The sloped surface 58 declines from a distal end of the hinge body towards the stand 110 at and angle Φ. When the hinge arm 52 is moved from the drying position 30, the sloped surface 58 uses the force of gravity to urge the hinge arm 52 and the air duct 20 to rotate towards the displaced position 32. In this exemplary embodiment, the air duct 20 needs to be manually reset to the drying position 30 when it is moved to the displaced position 32.

A hole 53 is illustrated through the middle of the hinge body 51 for the purpose of receiving a vertical section of the hinge arm 52. This configuration allows the vertical post of the hinge arm 52 to slide up and down in the center hole 53, permitting the hinge arm 52 to rotate within the hole while sliding along the contour of the resting channel 56 and sloped surface 58.

FIG. 7B illustrates the hinge body 51 of FIG. 7A, including an exemplary hinge arm 52. The hinge arm 52 is resting in the resting channel 56, and an attached air duct 20 would be situated in a drying position 30 over a vehicle 100 moving in a direction D1. FIG. 7C illustrates the hinge arm 52 of FIG. 7B rotated within the hinge body 51 into a displaced position 32. The hinge arm 52 is located on the sloped surface 58, such that gravity prevents the hinge arm 52 from moving back into the resting channel 56 without being reset, e.g., by a worker.

If the air duct 20 is pushed with sufficient force to rise over the second side 61 of the resting channel 56, the hinge arm 52 will rest on the sloped surface. Once on the sloped surface 58, the hinge arm 52 would tend to move away from the resting channel 56 and, therefore, away from the drying position 30 and towards the displaced position 32.

FIG. 8 illustrates an alternative embodiment of the drier station 10 having a round stand 210 and a sleeve 240. The sleeve 240 is dimensioned to rotate about the elongated portion 210a of the stand 210 as well as move up and down along the elongated portion 210a of the stand 210. The air duct 20 is connected by an exemplary weld connection to the sleeve 240 located to the round stand 210. The sleeve 240 can similarly include a plurality of roller bearings, lubrication, or other means for facilitating movement of the sleeve 240 up and down the stand 210. The air duct 20 is connected to the sleeve 240. The sleeve 240 is connected to a supply tube 24 providing high velocity air, and the high velocity air is channeled through the sleeve 240 into the air duct 20. The air duct 20 and the sleeve 240 can be described as a swinging arm.

A plurality of proximity sensors 22 are used to sense the location and distance between the air duct 20 and the vehicle 100. The proximity sensors 22 may be placed directly upon the air duct 20. The control module 60 receives a signal from the proximity sensors 22 and controls the drive 70 to move the sleeve 40 up and down the elongated portion of the stand 210.

The sleeve 240 is configured to move up and down as well as rotate about the axis 211 of the stand 210. The sleeve 240 can include bearings, lubrication, or some other means to reduce friction between the sleeve 240 and the stand 210 and permit the sleeve 240 to move freely up and down along the axis 211 of the stand 210. A support cable 71 is illustrated attached to the sleeve 240 at a connection point 72. The control module 60 controls the drive 70 to move the sleeve 240 up or down the elongated portion 210a. The support cable 71 is routed through a pulley 73 to permit a downward force from the drive 70 to result in an upward force upon the sleeve 240. The drive 70 can include a pneumatic or hydraulic cylinder known in the art. In another embodiment of the drive 70, the drive 70 is an electric motor pulling upon the support cable 71 or any control mechanism known in the art capable of moving the support cable 71. The control module 60 is configured as disclosed herein to monitor signals from the proximity sensors 22 and control the drive 70.

The vehicle 100 progresses through the drier station 10 along direction D1. The control module 60 receives a signal from the proximity sensors 22 and controls the drive 70 to move the sleeve 240 up and down axis the 211 of the stand 210 to follow the shape of the vehicle 100. As the sleeve 240 and the air duct 20 follow the shape of vehicle 100, high pressure air is directed by the outlets 21 onto the vehicle 100. The air duct 20 is fixedly mounted to the sleeve 240. The air duct 20 and the sleeve 240 are rotatable about the axis 211 between the drying position 30 and the displaced position 32. The air duct 20 is movable from the drying position 30 to the displaced position 32 such as when the vehicle 100 contacts the air duct 20 while moving in direction D1. In this embodiment, the sleeve 240 rotates with the air duct 20 when contacted by vehicle 100.

In a similar arrangement to that of FIG. 4, a pair of springs 82, 84 may be configured to restore the air duct 20 to the drying position 30 when it is moved to the displaced position 32. The pair of springs 82, 84 are affixed to opposing sides of the air duct 20 and biased against one another so that the air duct 20 is held in the drying position 30 when the pair of springs 82, 84 are in equilibrium. One of the pair of springs 82 is mounted to a first side of the air duct 20 and the other of the pair of springs 84 is mounted on the opposite side of the air duct 20. The sleeve 240 and the air duct 20 rotate about the axis 211 of the stand 210. In this exemplary embodiment, the pair of springs 82, 84 are configured to restore the air duct 20 to the drying position 30 when it is moved to the displaced position 32.

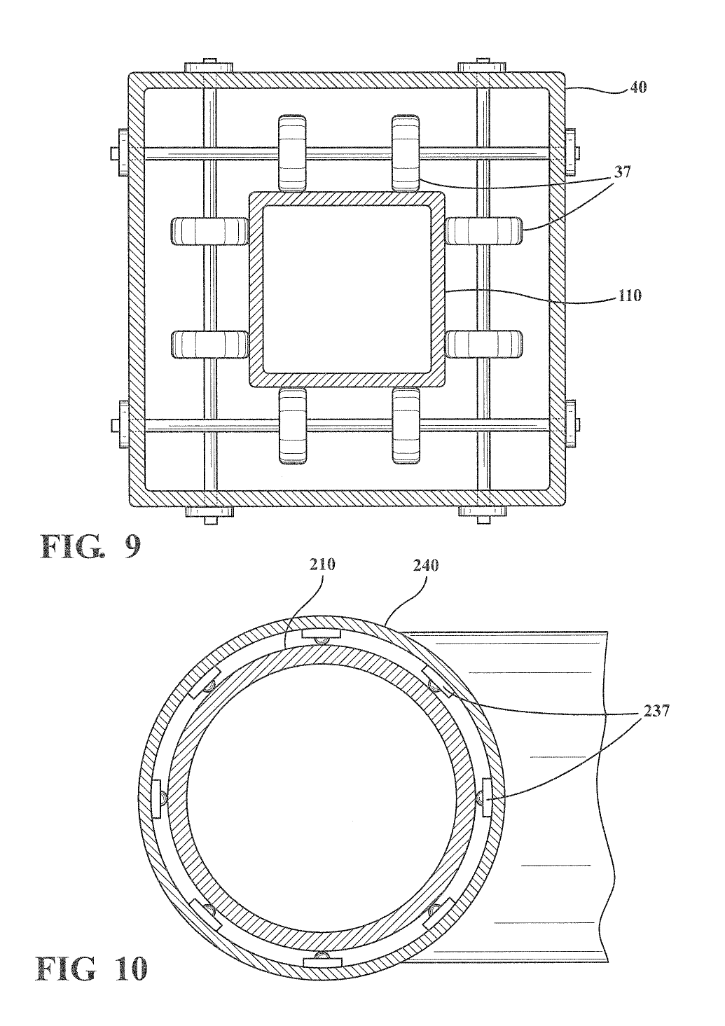

FIG. 9 illustrates a cross section of the sleeve 40 and stand 110 from FIG. 1. FIG. 10 illustrates a cross section of the sleeve 240 and stand 210 from FIG. 8. In FIG. 9, the sleeve 40 is illustrated located to the stand 110 with a plurality of roller wheels 37 connected to the sleeve 40. In this exemplary embodiment, two sets of eight roller wheels 37 can be utilized, although the cross-sectional view only shows one set, wherein the set being shown is located toward the top of the sleeve 40, the other set of eight roller wheels 37 (not shown) is disposed beneath the set of eight roller wheels 37 being shown, and each of the roller wheels 37 interacting with an orthogonal face of stand 110.

FIG. 10 illustrates a generally circular sleeve 240 and stand 210 from FIG. 8, including an alternative embodiment of roller bearings 237 that can be used to facilitate movement of the sleeve 240 about the stand 210. In this embodiment, roller bearings 237 are used to allow the sleeve 240 to move up and down the stand 210 as well as rotate about the axis 211 of the stand.

FIG. 11 illustrates an alternative embodiment of hinge assembly 50. In this embodiment the hinge body 51 has an open interior section such that the hinge arm 52 rests on an edge of the hinge body 51. The hinge body 51 is mounted to the sleeve 40 and has a resting channel 56 to hold the hinge arm 52 in the drying position 30. The resting channel 56 prevents the hinge arm 52 from moving from the drying position 30.

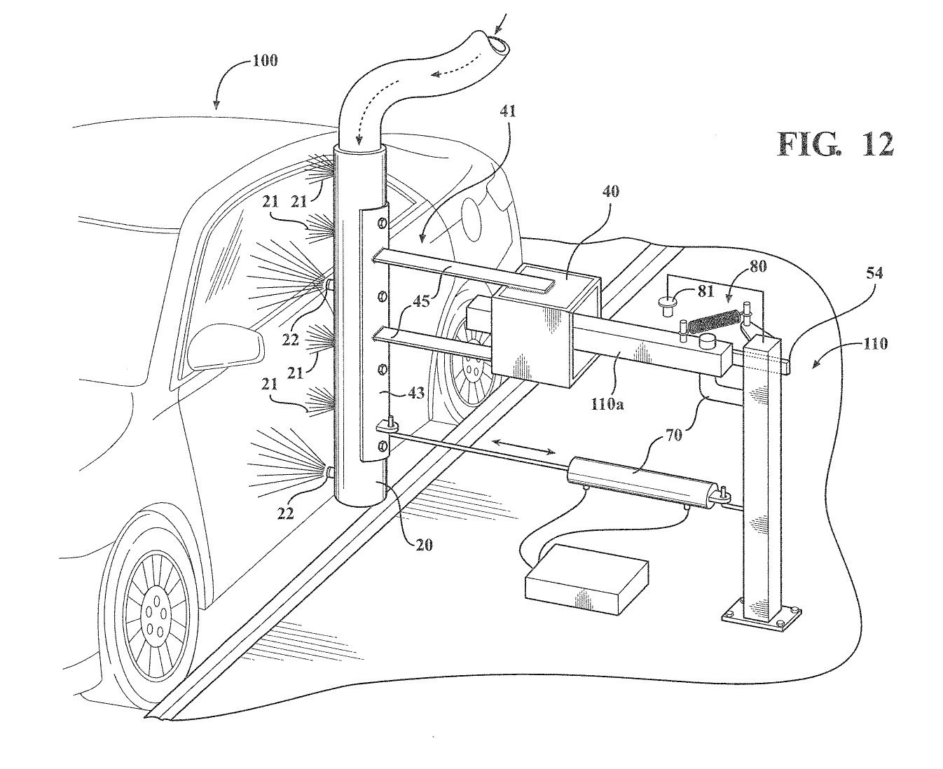

With reference now to FIG. 12, an embodiment of the drier station 10 wherein the air duct 20 is configured to dry the side surface of the vehicle 100 is provided. The stand 110 is shown as a post extending generally upright. The elongated portion 110a extending along a generally horizontal axis. The air duct 20 is disposed on one end of the elongated portion 110a. The elongated portion 110a is pivotably mounted to the stand at the other end. For example, a hinge assembly 50 having a hinge arm 52 which is generally “L” shaped is mounted to an interior side of the stand 110. The elongated portion 110a includes an opening 71 for which a portion of the hinge arm 52 is slid therein. The elongated portion 110a pivots about the hinge arm 52.

Thus, the air duct 20 is pivoted away from the vehicle 100 in the event the vehicle 100 contacts the air duct 20. A return device 80 is configured to return the air duct 20 to the drying position 30. The return device 80 also holds a stop 54 to ensure that the air duct 20 is in the drying position 30 after the vehicle impacts the air duct 20. The return device may be, for example, a pneumatic cylinder, hydraulic cylinder, or a spring.

As with the top down embodiment, the sleeve 40 is dimensioned to fit around the elongated portion 110a of the stand 110 and also move along the elongated portion of the stand. The distal end of the sleeve 40 includes an attachment member 41 fixedly connected to the air duct 20. The attachment member may include a bracket 43 fixedly mounted to a back side of the air duct 20 and a pair of arms 45 connecting the bracket 43 to the sleeve 40. The plurality of sensors 22 may be mounted to adjacent the outlets 20. The control module 60 and the drive 70 are configured to control the movement of the sleeve 40 along the elongated portion 110a of the stand 110 so as to move the air duct 20 along a generally horizontal axis following the contour of the side of the vehicle as determined by sensors 22. The air duct 20 is configured to direct high velocity air onto the side outer surface of the vehicle 100.

The hinge assembly 50 is operatively mounted to the air duct 20 and configured to rotate the air duct 20 between the drying position and a displaced position. More specifically, the hinge assembly 50 pivotably mounts the distal end of the elongated portion 110a to the stand 110. Thus, if the vehicle contacts the air duct 20, the air duct 20 pivots away, in the direction of movement of the vehicle 100, so as to prevent the air duct 20 from damaging the vehicle 100. For instance, switch 81 activates cylinder 80 so as to rotate the elongated portion 90 degrees forward, with respect to the movement of the vehicle 100, so as to prevent damage to the vehicle 100.

The invention is not restricted to the illustrative examples described above. Examples described are not intended to limit the scope of the invention. Changes therein, other combinations of elements, and other applications will occur to those skilled in the art without deviating from the spirit of the described invention.

1. A drier station for a carwash configured to dry the outer surface of a vehicle, the drier station comprising:
a stand having an elongated portion extending along an axis;
a sleeve dimensioned to fit around the elongated portion, the sleeve configured to move along the elongated portion of the stand;
a plurality of proximity sensors;
a control module and a drive configured to control the movement of the sleeve along the elongated portion of the stand, the control module receiving sensor data from the sensors;
an air duct configured to direct high velocity air onto the outer surface of the vehicle; and
a hinge assembly operatively mounted to the air duct and configured to rotate the air duct between the drying position and a displaced position.

2. The drier station for a carwash as set forth in claim 1, wherein the hinge assembly is mounted to the sleeve, the hinge assembly having a hinge body and a hinge arm, the hinge body adapted to receive the hinge arm, the sleeve configured to move vertically along the elongated portion of the stand, and wherein the hinge assembly is further configured to rotate the air duct along a plane generally orthogonal to the axis of the elongated portion of the stand.

3. The drier station as set forth in claim 2, wherein the hinge body includes a resting channel dimensioned to hold the hinge arm in a fixed relationship with the hinge body and in the drying position.

4. The drier station as set forth in claim 3, wherein the hinge body has a sloped surface configured to urge the hinge arm to the displaced position when the air duct is moved from the drying position.

5. The drier station as set forth in claim 3, further comprising:
a stop disposed on a surface of the hinge body coplanar with the hinge arm, the stop configured to prevent the hinge arm from rotating beyond the drying position; and
a return device configured to return the air duct to the drying position and hold the hinge arm in contact with the stop.

6. The drier station of claim 5, wherein the return device is a pneumatic cylinder and is further configured to facilitate the movement of the air duct from the drying position to the displaced position.

7. The drier station of claim 5, wherein the return device is a spring.

8. The drier station of claim 5, wherein the hinge body has a sloped surface configured to urge the hinge arm to the displaced position when the air duct is moved from the drying position.

9. The drier station of claim 2, further comprising:
a pair of springs attached to the air duct, one of the pair of springs is mounted on a first side of the air duct and the other of the pair of springs is mounted on a side opposite the first side.

10. The drier station of claim 2, wherein the sleeve has a rectangular cross section.

11. The drier station of claim 2, wherein the sleeve has a plurality of roller wheels, the roller wheels in contact with the elongated portion of the stand, and the roller wheels aligned with the axis of the elongated portion of the stand.

12. The drier station of claim 2, wherein the sleeve has a plurality of bearings, the bearings in contact with the elongated portion of the stand.

13. A drier station for a carwash comprising:
a stand having an elongated portion having an axis;
a sleeve dimensioned to rotate about the elongated portion of the stand, the sleeve configured to move up and down along the elongated portion of the stand;
a plurality of proximity sensors;
a control module and a drive configured to control the movement of the sleeve along the elongated portion of the stand, the control module receiving sensor data from the sensors;
an air duct fixedly mounted to the sleeve, the air duct extending orthogonally outward from the axis of the stand in a drying position, and the air duct and the sleeve rotatable along a plane generally orthogonal to the axis of the stand between the drying position and a displaced position.

14. The drier station of claim 13, further comprising:
a return device configured to return the air duct to the drying position.

15. The drier station of claim 14, wherein the return device is a pneumatic cylinder, and is further configured to facilitate the movement of the air duct from the drying position to the displaced position.

16. The drier station of claim 14, wherein the return device is a pair of springs attached to the air duct, one of the pair of springs is mounted on a first side of the air duct and the other of the pair of springs is mounted on a side opposite the first side.

17. The drier station of claim 13, wherein the sleeve has a circular cross section.

18. The drier station of claim 13, wherein the sleeve has a plurality of bearings, the plurality of bearings in contact with the elongated portion of the stand.

19. The drier station as set forth in claim 1, wherein the elongated portion extends along a horizontal axis, the air duct is disposed along a plane generally vertical and is configured to direct high velocity air onto the outer side surface of the vehicle, and the hinge assembly is mounted to an end portion of the elongated portion so as to rotate the air duct between the drying position and a displaced position.
